(19) United States
(12) Patent Application Publication
(10) Pub. No.: US 2021/0025211 A1
(43) Pub. Date: Jan. 28, 2021

(54) Lamp Assembly for Garage Door Panel

(71) Applicant: Peter Robert DICKSON, Mount Albert (CA)

(72) Inventor: Peter Robert DICKSON, Mount Albert (CA)

(21) Appl. No.: 16/888,936

(22) Filed: Jun. 1, 2020

Related U.S. Application Data
(60) Provisional application No. 62/878,925, filed on Jul. 26, 2019.

(51) Int. Cl. E05F 15/47; E06B 7/28; E06B 9/13; E06B 9/17; E06B 9/80

(52) U.S. Cl. CPC E05F 15/47; E06B 7/28; E06B 2009/6836; E06B 9/17046; E06B 9/80; E06B 9/13

(57) ABSTRACT

An apparatus includes a lamp assembly having a clamp assembly. The clamp assembly is configured to be securely attached to a section of a garage door panel.

### TECHNICAL FIELD

This document relates to the technical field of (and is not limited to) a lamp assembly for a garage door panel, and/or a garage door panel having a lamp assembly.

### BACKGROUND

A garage door opener is configured to open and close a garage door relative to a garage doorway (opening) having an upper end, a lower end, and two opposite side edges. A safety light assembly may be utilized with the garage door opener.

### SUMMARY

It will be appreciated that there exists a need to mitigate (at least in part) at least one problem associated with the existing lamps for garage doors (also called the existing technology). After much study of, and experimentation with, the existing lamps for garage doors, an understanding (at least in part) of the problem and its solution have been identified (at least in part) and are articulated (at least in part) as follows:

The known safety light assembly (utilized with the known garage door opener) may be configured to (A) turn on (activate) for the case where the garage door opens (and/or via activation of a motion sensor), and (B) turn off (deactivate) after a preset delay. The known safety light assembly is positioned above the vehicular parking spot positioned within the garage; the light that is emitted from the safety light assembly is directed to the vehicular parking spot (the floor).

A problem with this arrangement is that the driver of the vehicle may not be able to visually confirm for their own satisfaction that the garage door is fully open before safely moving the vehicle away from the vehicular parking spot and through the garage doorway.

It may be beneficial to provide a safety light assembly configured to be securely attached to a garage door.

It may be beneficial to provide a safety light assembly that is attachable to a bottom edge of a garage door.

It may be beneficial to provide a safety light assembly that is positioned in line with a garage door (that is, the safety light assembly does not extend much past the outer surface of the garage door, so that the light assembly does not become accidentally removed from the garage door).

A technical effect for this arrangement is that once the garage door is made to be moved (upwardly or downwardly), the light that is emitted from the safety light assembly is directed to the driver of the vehicle positioned in the vehicular parking spot (the floor). In this manner, the driver of the vehicle may be able to visually confirm for their own satisfaction that the garage door is fully open before safely moving the vehicle away from the vehicular parking spot and through the garage doorway.

To mitigate, at least in part, at least one problem associated with the existing technology, there is provided (in accordance with a major aspect) an apparatus. The apparatus includes and is not limited to (comprises) a lamp assembly having a clamp assembly. The clamp assembly is configured to be securely attached to a section of a garage door panel.

To mitigate, at least in part, at least one problem associated with the existing technology, there is provided (in accordance with a major aspect) an apparatus. The apparatus includes and is not limited to (comprises) a garage door panel, and a lamp assembly having a clamp assembly. The clamp assembly is configured to be securely attached to a section of the garage door panel.

To mitigate, at least in part, at least one problem associated with the existing technology, there is provided (in accordance with a major aspect) an apparatus. The apparatus includes and is not limited to (comprises) a profile body configured to be attached to a garage door panel including a flexible rubber sheet. A door-release device is configured to be slidably received, at least in part, into an end portion of the profile body. The profile body includes a support portion that slidably abuts an outer side of the door-release device. The door-release device is configured to slide engage with a garage door support along a length of an elongated groove extending vertically along a length of the garage door support. The garage door panel is configured to be movable while the door-release device remains vertically slide engaged with the garage door support. The door-release device is configured to permit the garage door panel to become disengaged from a garage door support, once a vehicle strikes a side of the garage door panel, and the garage door panel centrally buckles.

To mitigate, at least in part, at least one problem associated with the existing technology, there is provided (in accordance with a major aspect) an apparatus. The apparatus includes and is not limited to (comprises) a lamp assembly and a clamp assembly configured to securely attach the lamp assembly to a section of a garage door panel. The lamp assembly is positioned, at least in part, in-line within the garage door panel once the clamp assembly attaches the lamp assembly to the section of the garage door panel. The lamp assembly includes the profile body defining a hollow interior. The profile body forms a first lamp receiver and a second lamp receiver that are positioned on opposite faces of the profile body (in which the opposite faces) of the profile body are positioned at the opposite sides of the garage door panel once the clamp assembly attaches the lamp assembly to the section of the garage door panel. The profile body is configured to receive and support a sensor assembly, and the sensor assembly is configured to detect pressure of the garage door panel closing down to a work surface. The profile body is also configured to receive and support a safety edge, and the safety edge is configured to cover the sensor assembly once the sensor assembly and the safety edge are attached to the lamp assembly.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a front view of an embodiment of a lamp assembly and a garage door panel; and

FIG. 2 depicts a schematic view of an embodiment of the lamp assembly; and

FIG. 3, FIG. 4 and FIG. 5 depict a top view (FIG. 3), a side view (FIG. 4) and a front perspective view (FIG. 5) of embodiments of the lamp assembly and the garage door panel of FIG. 1; and

FIG. 6 depicts a close-up perspective view of an embodiment of the lamp assembly of FIG. 1; and

FIG. 7 depicts a cross-sectional view of an embodiment of the lamp assembly of FIG. 1; and

FIG. 8 depicts a cross-sectional view of an embodiment of the lamp assembly of FIG. 1; and

FIG. 9 and FIG. 10 depict a side view (FIG. 9) of an embodiment of a sensor assembly and a side view (FIG. 10) of an embodiment of a safety edge, both of the lamp assembly of FIG. 1; and

FIG. 11 and FIG. 12 depict cross-sectional side views of embodiments of the lamp assembly of FIG. 1; and

FIG. 13 depicts a cross-sectional view of an embodiment of the lamp assembly of FIG. 1 and a first door-release device A of the garage door panel of FIG. 1; and

FIG. 14 depicts a side view of an embodiment of the first door-release device A of FIG. 13; and

FIG. 15 and FIG. 16 depict top views of embodiments of the first door-release device A of FIG. 13 with the garage door panel of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

| | |
|---|---|
| Apparatus | 100 |
| drive unit | 101 |
| window assembly | 102 |
| Assembly | 104 |
| garage door panel | 106 |
| control panel | 108 |
| main power panel | 109 |
| barrel - support assembly | 110 |
| barrel assembly | 112 |
| emergency brake | 113 |
| safety indicator | 114 |
| safety edge | 116 |
| door-release device | 118 |
| garage door support | 120 |
| elongated groove | 121 |
| lamp assembly | 122 |
| lamp connection | 123 |
| barrel pulley assembly | 124 |
| photo eye assembly | 126 |
| reflector assembly | 127 |
| lamp cord | 128 |
| electrical housing | 130 |
| Connector | 132 |
| profile body | 134 |
| connector channel | 136 |
| garage door support | 120 |
| lamp receiver | 138 |
| lamp cover receiver | 140 |
| sensor receiver | 142 |
| seal receiver | 144 |
| clamp assembly | 145 |
| door contact portion | 146 |
| plate receiver | 148 |
| lamp cover | 150 |
| lamp device | 152 |
| connector support | 154 |
| sensor assembly | 156 |
| air-tube assembly | 157 |
| conduit assembly | 158 |
| pressure sensor | 159 |
| first conduit | 160 |
| second conduit | 162 |
| support portion | 165 |
| support portions | 165 |
| groove | 166 |
| lateral cross-brace | 167 |
| extended portion | 168 |
| extended portion | 170 |
| rigid garage door panel | 172 |
| work surface | 900 |
| working surface | 900 |
| vehicle | 902 |
| vehicle movement direction | 903 |

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

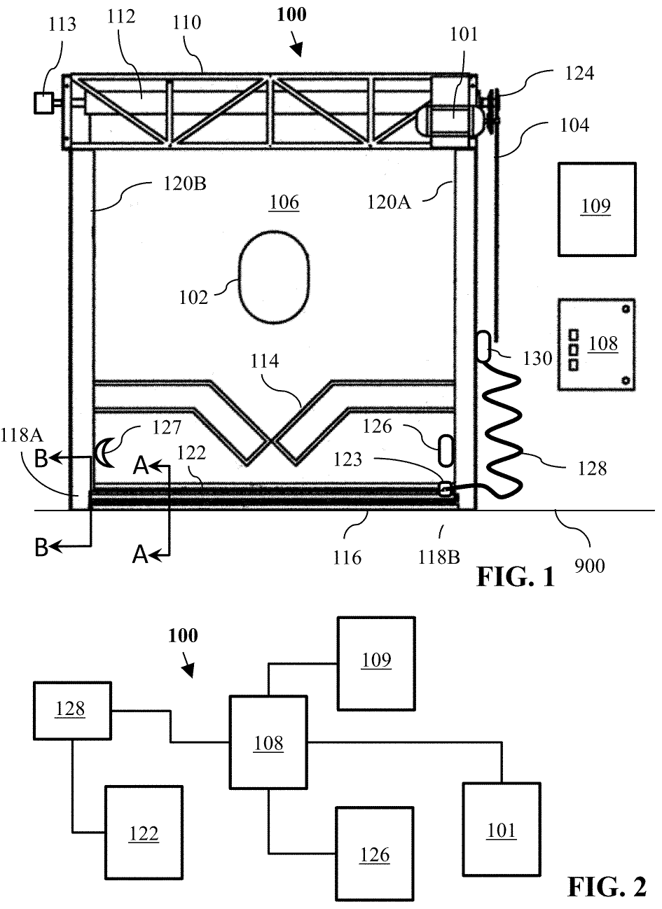

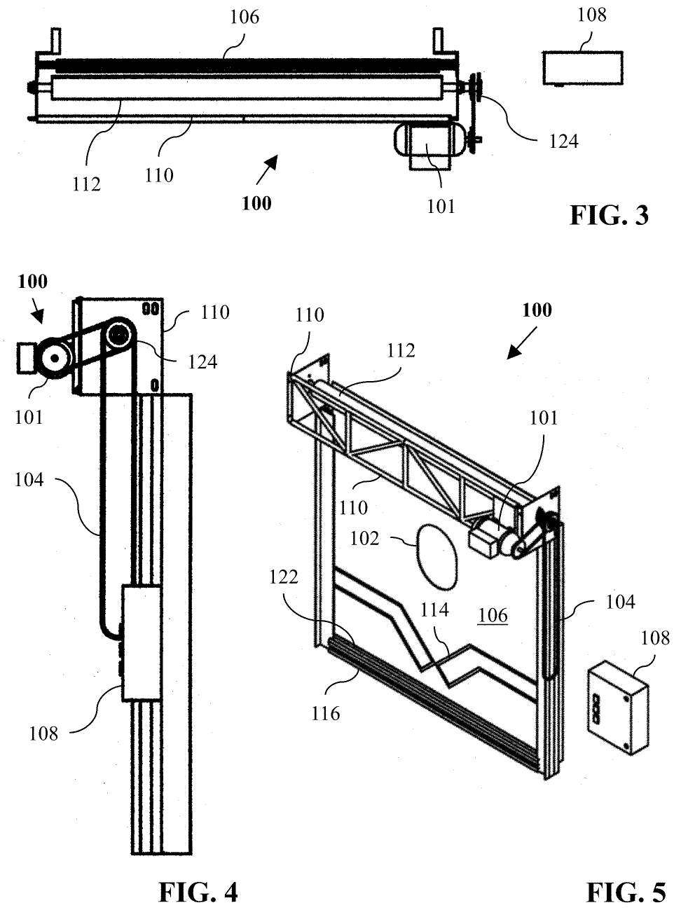

FIG. 1 depicts a front view of an embodiment of a lamp assembly 122 and a garage door panel 106. FIG. 2 depicts a schematic view (electrical schematic view) of an embodiment of the lamp assembly 122. FIG. 3, FIG. 4 and FIG. 5 depict a top view (FIG. 3), a side view or an operator view (FIG. 4) and a front perspective view (FIG. 5) of embodiments of the lamp assembly 122 and the garage door panel 106 of FIG. 1.

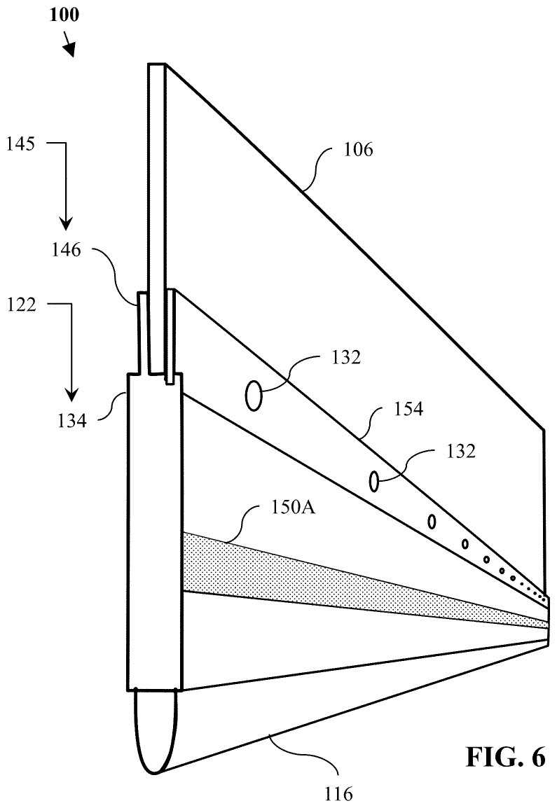

Referring to the embodiment as depicted in FIG. 1, there is depicted a first aspect in which an apparatus 100 includes and is not limited to (comprises) a synergistic combination of a lamp assembly 122 and a clamp assembly 145. Preferably, the lamp assembly 122 has the clamp assembly 145 integrally formed to the lamp assembly 122 (an embodiment of the clamp assembly 145 is depicted in FIG. 6). The clamp assembly 145 is configured to be securely attached to a section of a garage door panel 106. The garage door panel 106 is configured for closing a garage doorway (known and not depicted) having an upper end, a lower end, and two opposite side edges. The garage doorway is formed on the outer wall of a building. The lamp assembly 122 may include an LED strip manufactured or provided by ALITOV (TRADEMARK). In accordance with a preferred embodiment, the apparatus 100 includes a synergistic combination of the lamp assembly 122 and the clamp assembly 145 configured to securely attach the lamp assembly 122 to a section of a garage door panel 106.

Referring to the embodiment as depicted in FIG. 1, there is depicted a second aspect in which an apparatus 100 includes and is not limited to (comprises) a synergistic combination of a garage door panel 106 and a lamp assembly 122. The garage door panel 106 is configured for closing a garage doorway having an upper end, a lower end, and two opposite side edges. The lamp assembly 122 has a clamp assembly 145 (an embodiment of which is depicted in FIG. 6). The clamp assembly 145 is configured to be securely attached to a section of the garage door panel 106.

Referring to the embodiment as depicted in FIG. 1, the clamp assembly 145 (of the lamp assembly 122) is (preferably) configured to attach the lamp assembly 122 to a bottom edge of the garage door panel 106.

Referring to the embodiment as depicted in FIG. 1, the lamp assembly 122 is (preferably) positioned in-line within (that is, mounted in-line within, at least in part, the body of) the garage door panel 106 once the clamp assembly 145 attaches the lamp assembly 122 to a section of the garage door panel 106 (preferably, attached to the bottom edge of the garage door panel 106). More specifically, once the lamp assembly 122 is positioned in-line (at least in part) within the garage door panel 106, the lamp assembly 122 does not extend much past an outer surface (the outer surfaces) of the garage door panel 106 so that the lamp assembly 122 does not become accidentally removed from the garage door panel 106 by someone or something inadvertently striking the lamp assembly 122.

Referring to the embodiment as depicted in FIG. 1, the lamp assembly 122 is (preferably) positioned and mounted (at least in part) in-line with a vertical axis that extends (top to bottom) along the body of the garage door panel 106 (once the clamp assembly 145 attaches the lamp assembly 122 to a section of the garage door panel 106).

Referring to the embodiment as depicted in FIG. 1 to FIG. 5, a drive unit 101 is (preferably) configured for connection (either directly or indirectly) with the garage door panel 106. The drive unit 101 is also configured to raise and lower the garage door panel 106 relative to a working surface 900 (once the drive unit 101 is activated accordingly). The drive unit 101 may be called a door mover assembly, a door lift assembly, an electrical motor, a curtain winding mechanism, etc. The drive unit 101 may include a digitally-encoded electrical motor, etc. The drive unit 101 may include the MICANAN (TRADEMARK) MODEL PRO-FDGH drive unit (MICANAN is based in Quebec, Canada).

Referring to the embodiment as depicted in FIG. 1 and FIG. 5, a window assembly 102 is (preferably) mounted to a central zone of the garage door panel 106. The window assembly 102 may be translucent (to let natural sunlight into the interior of the garage).

Referring to the embodiment as depicted in FIG. 1, FIG. 4 and FIG. 5, an auxiliary hoist assembly 104 is (preferably) configured for connection (either directly or indirectly) with the garage door panel 106. The auxiliary hoist assembly 104 is also configured to (manually) raise and lower the garage door panel 106 relative to a working surface 900 (once manually activated). The auxiliary hoist assembly 104 may include, for instance, a manual hoist, a chain, a manual lift device, etc. The auxiliary hoist assembly 104 may be utilized, for instance, for the case where the drive unit 101 fails to operate (as a manual override for lifting the garage door panel 106).

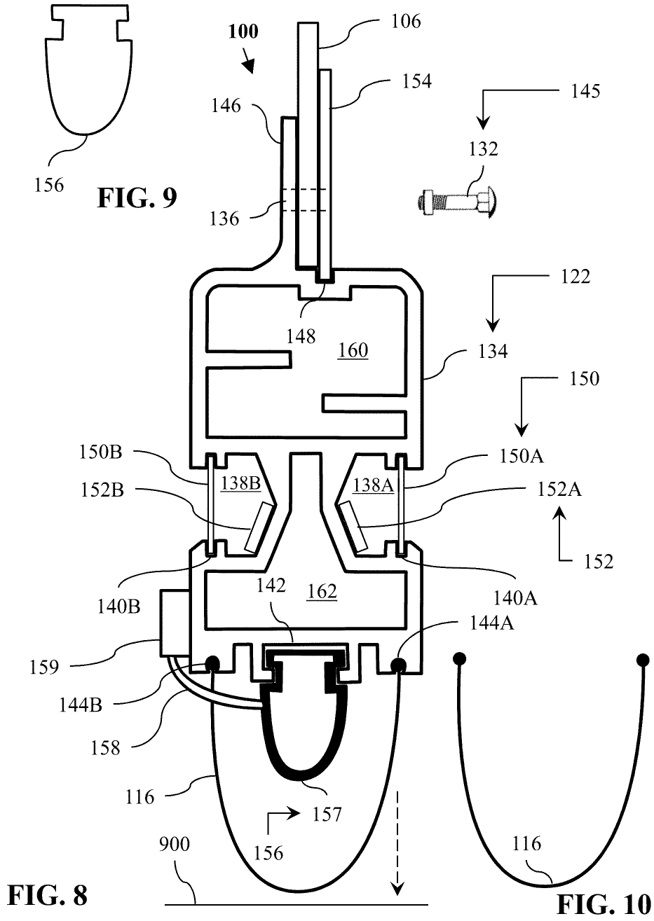

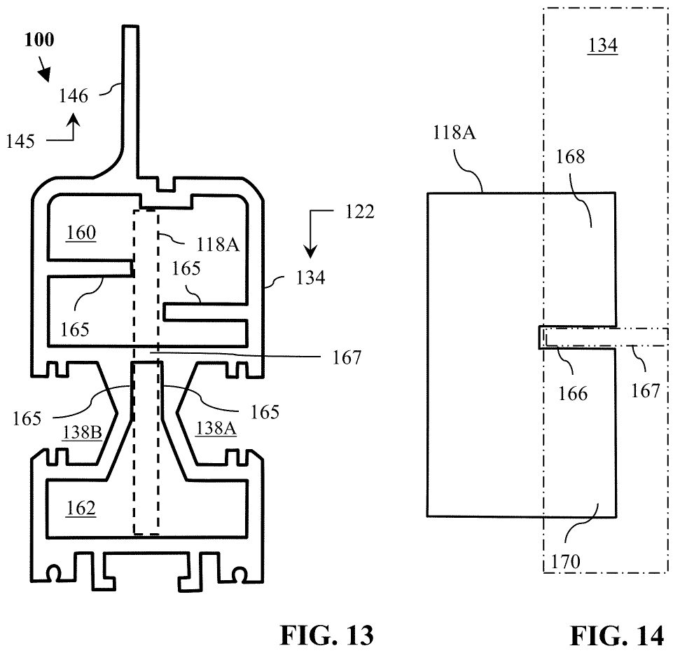

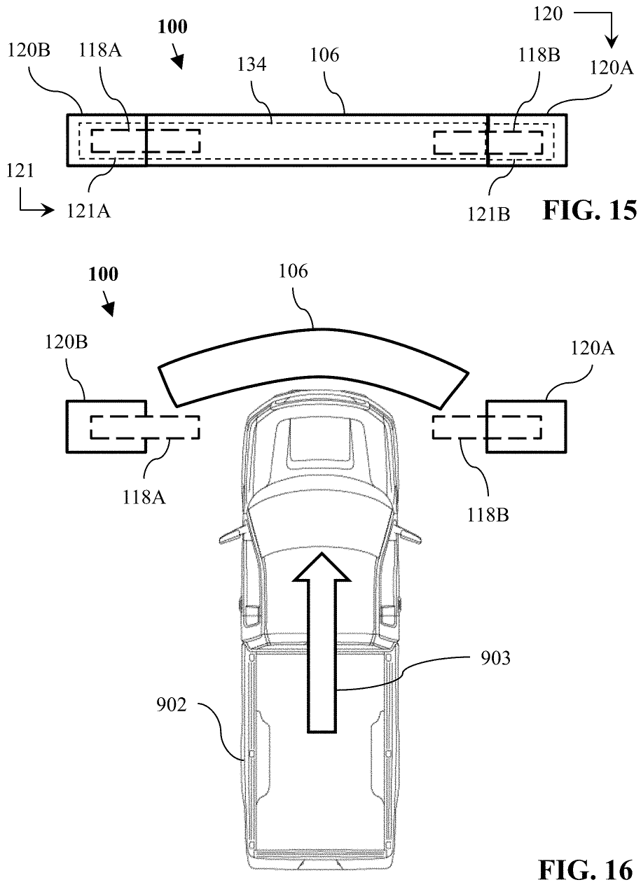

Referring to the embodiment as depicted in FIG. 1 and FIG. 5, the garage door panel 106 includes a flexible sheet, flexible rubber sheet, a rubber curtain assembly or a flexible rubber web (as depicted in the embodiments of FIG. 1, FIG. 5, FIG. 6, FIG. 8, FIG. 15 and FIG. 16). The flexible sheet (preferably) forms a curtain for closing a doorway having an upper end, a lower end, and two opposite side edges. The flexible sheet has a relatively thin main area and elongated side edge sections. Alternatively, the garage door panel 106 may include a ridged metal panel (as depicted in the embodiments of FIG. 13 and FIG. 14).

Referring to the embodiment as depicted in FIG. 1 to FIG. 5, a control panel 108 includes (preferably) an industrial logic controller. The control panel 108 is configured to be wall mountable. The control panel 108 is electrically connected to a main power panel 109.

Referring to the embodiment as depicted in FIG. 1, FIG. 3 and FIG. 5, a barrel assembly 112 is deployed for the case where the garage door panel 106 includes a flexible rubber sheet. The barrel assembly 112 may be called a support brace, a lateral brace, a frame assembly, etc. A barrel-support assembly 110 is configured to support the barrel assembly 112.

Referring to the embodiment as depicted in FIG. 1, an emergency brake 113 is configured to stop movement of the garage door panel 106 (in case of emergency situations).

Referring to the embodiment as depicted in FIG. 1 and FIG. 5, a safety indicator 114 is positioned on a flat surface of the garage door panel 106. The safety indicator 114 includes a light-reflective material (stripe).

Referring to the embodiment as depicted in FIG. 1 and FIG. 5, a safety edge 116 is mounted to the bottom edge portion of the lamp assembly 122. The safety edge 116 may be called a seal or a protector. A bottom edge portion of the lamp assembly 122 is configured to be connected to a safety edge 116. The safety edge 116 may include the MODEL 106-.25RC seal device (manufactured or supplied by CANADA RUBBER GROUP INC. based in Ontario, Canada.

Referring to the embodiment as depicted in FIG. 1, a first garage door support 120A and a second garage door support 120B are spaced apart from each other. For the case where the garage door panel 106 includes a flexible rubber sheet, the first garage door support 120A and the second garage door support 120B include a curtain support or a curtain support angle. The first garage door support 120A and the second garage door support 120B include (form) a pair of spaced-apart guide channels; the spaced-apart guide channels are configured to be engageable with the outer lateral side edges of the garage door panel 106.

Referring to the embodiment as depicted in FIG. 1 and FIG. 5, the lamp assembly 122 is securely positioned to the bottom edge portion of the garage door panel 106. The lamp assembly 122 is configured to emit a flashing light once the lamp assembly 122 is activated. The lamp assembly 122 is electrically connected to the control panel 108. The controller housed in the control panel 108 is configured to urge a flashing operation of the lamp assembly 122 once the controller sends a signal to the drive unit 101 to move the garage door panel 106. The lamp assembly 122 is configured to emit a flashing light once the lamp assembly 122 is activated in response to movement of the garage door panel 106.

Referring to the embodiment as depicted in FIG. 1 and FIG. 3, a barrel pulley assembly 124 is configured to engage the drive unit 101 with the barrel assembly 112.

Referring to the embodiment as depicted in FIG. 1, a photo eye assembly 126 and a reflector assembly 127 are mounted to the bottom section of the first garage door support 120A and the second garage door support 120B. The photo eye assembly 126 is electrically connected to the control panel 108 (to the controller, which is known and not depicted, positioned within the control panel 108). The photo eye assembly 126 is configured to detect the presence of a vehicle (to avoid unwanted collision of the garage door panel 106 with the vehicle that may be parked underneath the garage door panel 106).

Referring to the embodiment as depicted in FIG. 1, a coiled lamp cord 128 extends from a lamp connection 123 of the lamp assembly 122. An electrical housing 130 is attached to the first garage door support 120A. The coiled lamp cord 128 terminates at the electrical housing 130. The coiled lamp cord 128 is wired to the control panel 108 via the electrical housing 130.

Referring to the embodiment as depicted in FIG. 1, a first door-release device 118A and a second door-release device 118B (also depicted in FIG. 14, FIG. 15 and FIG. 16) are mounted to the opposite end portions of the lamp assembly 122. The first door-release device 118A and the second door-release device 118B are deployed for the case where the garage door panel 106 includes a flexible rubber sheet. The first door-release device 118A and the second door-release device 118B may be called an impact plate, a frangible element, a mechanical fuse, etc.

Referring to the embodiment as depicted in FIG. 2, the main power panel 109 is electrically connected to (either directly or indirectly) to the control panel 108. The main power panel 109 is configured to supply electrical power to the control panel 108. The control panel 108 is configured to provide electrical power to the coiled lamp cord 128, the photo eye assembly 126 and the drive unit 101. The lamp assembly 122 is electrically connected to the control panel 108 via the coiled lamp cord 128.

FIG. 6 depicts a close-up perspective view of an embodiment of the lamp assembly 122 of FIG. 1.

Referring to the embodiment as depicted in FIG. 6, the lamp assembly 122 includes a profile body 134. The clamp assembly 145 includes a connector 132 (such as a bolt and nut). The profile body 134 is configured to be attached to the bottom portion of the garage door panel 106 (such as along the bottom edge portion of the garage door panel 106). The garage door panel 106 is positioned between (sandwiched between) the door contact portion 146 (which extends upwardly from the profile body 134) and the connector support 154. The connector 132 connects the connector support 154 and the door contact portion 146 to the garage door panel 106. The safety edge 116 is attached to the bottom edge of the profile body 134 (opposite from the door contact portion 146). The profile body 134 is configured to receive and support a safety edge 116.

Referring to the embodiment as depicted in FIG. 6, the clamp assembly 145 includes a connector 132 and a connector support 154. The profile body 134 includes a door contact portion 146 extending from the profile body 134. The garage door panel 106 is configured to be sandwiched between the door contact portion 146 of the profile body 134 and the connector support 154.

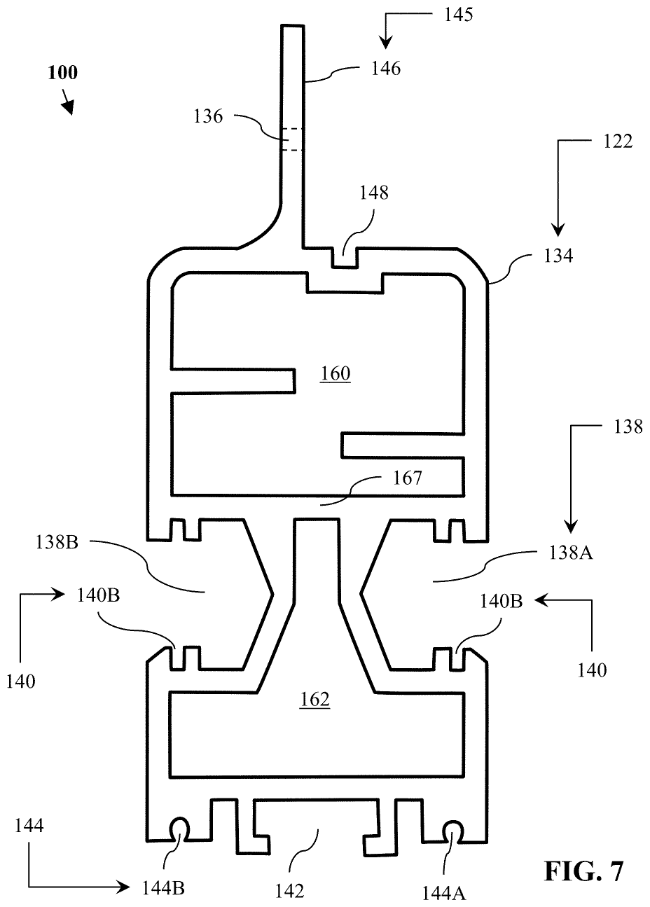

FIG. 7 depicts a cross-sectional view (through a cross-sectional line A-A as depicted in FIG. 1) of an embodiment of the lamp assembly 122 of FIG. 1.

Referring to the embodiment as depicted in FIG. 7, the components are not mounted to the lamp assembly 122 (for ease of depiction). The lamp assembly 122 includes the profile body 134. The profile body 134 is (preferably) formed from an extruded aluminum profile.

Referring to the embodiment as depicted in FIG. 7, the profile body 134 includes the door contact portion 146. The lamp assembly 122 includes the profile body 134 having (defining) a hollow interior. The door contact portion 146 extends (upwardly) from the profile body 134. A connector channel 136 is formed in (through) the door contact portion 146 (between the opposite sides of the door contact portion 146). The top section of the profile body 134 forms (includes) a plate receiver 148 configured to receive (at least in part) a frontal edge portion of the connector support 154 (as depicted in FIG. 8).

Referring to the embodiment as depicted in FIG. 7, the profile body 134 is configured to form (provide) at least one lamp receiver (138A, 138B), such as the first lamp receiver 138A and the second lamp receiver 138B. The first lamp receiver 138A and the second lamp receiver 138B are positioned on opposite side faces (opposite sides, opposite faces) of the profile body 134; the opposite faces or opposite sides of the profile body 134 are positioned at (on) the opposite sides of the garage door panel 106 (the profile body 134 forms a first lamp receiver 138A and a second lamp receiver 138B each of which are positioned on opposite faces of the profile body 134.

Referring to the embodiment as depicted in FIG. 7, within the inner surface of at least one lamp receiver (138A, 138B) there is provided at least one lamp cover receiver (140A, 140B), such as a first lamp cover receiver 140A and a second lamp cover receiver 140B. The profile body 134 forms (preferably) at least one lamp cover receiver (140A, 140B).

Referring to the embodiment as depicted in FIG. 7, the profile body 134 includes a sensor receiver 142 configured to receive and support a sensor assembly 156 (as depicted in FIG. 8). The sensor assembly 156 is configured to detect pressure of the garage door panel 106 closing down onto the work surface 900. The profile body 134 is configured to receive and support a sensor assembly 156.

Referring to the embodiment as depicted in FIG. 7, the profile body 134 includes at least one seal receiver (144A, 144B) configured to receive and support the safety edge 116 (as depicted in FIG. 8).

Referring to the embodiment as depicted in FIG. 7, the profile body 134 defines (provides) a first conduit 160 and a second conduit 162, which are spaced apart from each other. The profile body 134 includes a lateral cross-brace 167 that bisects the interior of the profile body 134 into the first conduit 160 and the second conduit 162.

FIG. 8 depicts a cross-sectional view (through the cross-sectional line A-A as depicted in FIG. 1) of an embodiment of the lamp assembly 122 of FIG. 1 (in which components are mounted to the lamp assembly 122).

Referring to the embodiment as depicted in FIG. 8, the door contact portion 146 extends from a top portion of the profile body 134. One side of the bottom portion of the garage door panel 106 is positioned against (abuts) one side of the door contact portion 146. The bottom edge of the garage door panel 106 contacts (abuts) the top portion of the profile body 134. The connector support 154 contacts a lower face side (exposed side) of the garage door panel 106. The connector 132 is inserted into the connector channel 136 (defined by the door contact portion 146, the garage door panel 106 and the connector support 154, once these components are aligned as depicted). The connector 132 is (then) engaged (bolt and nut are tightened).

Referring to the embodiment as depicted in FIG. 8, the first lamp device 152A (such as an LED strip) is positioned into the first lamp receiver 138A. The second lamp device 152B (such as an LED strip) is positioned into the second lamp receiver 138B.

Referring to the embodiment as depicted in FIG. 8, the lamp covers (150A, 150B) are inserted into their respective grooves.

Referring to the embodiment as depicted in FIG. 8, the safety edge 116 is configured to be fixedly mounted to the bottom section of the lamp assembly 122. The safety edge 116 is configured to cover the sensor assembly 156 once the sensor assembly 156 and the safety edge 116 are fixedly attached to the bottom section of the lamp assembly 122 (as depicted in FIG. 8); that is, the safety edge 116 is also configured to cover the sensor assembly 156 once the sensor assembly 156 and the safety edge 116 are attached to the lamp assembly 122.

Referring to the embodiment as depicted in FIG. 8, the sensor assembly 156 is configured to be fixedly mounted to the bottom section of the lamp assembly 122. The sensor assembly 156 includes (preferably) an air-tube assembly 157, a conduit assembly 158, and a pressure sensor 159. The air-tube assembly 157 is mounted to the bottom section of the profile body 134 (to the bottom section of the lamp assembly 122). The pressure sensor 159 is mounted to an outer facing side of the profile body 134 (to the bottom section of the lamp assembly 122). The conduit assembly 158 fluidly connects the pressure sensor 159 with the air-tube assembly 157. Once the garage door panel 106 moves toward the working surface 900, the safety edge 116 makes contact with the working surface 900, and the safety edge 116 collapses. Continued movement of the garage door panel 106 toward the vehicle 902 causes the air-tube assembly 157 to contact the safety edge 116. The fluid (air) pressure within the interior of the air-tube assembly 157 is urged to increase, and the pressure sensor 159 senses the increase in fluid pressure (via the conduit assembly 158). The pressure sensor 159 includes a transmitter device configured to transmit a signal (radio frequency signal) to the controller (housed in the control panel 108 of FIG. 1) to indicate that the garage door panel 106 has reached its travel limit so that the controller may then shut off further operation of the drive unit 101 (as depicted in FIG. 1). The pressure sensor 159 may include the Model TR200 sensor device (manufactured or supplied by VITECTOR based in New Jersey, U.S.A.).

FIG. 9 and FIG. 10 depict a side view (FIG. 9) of an embodiment of a sensor assembly 156 and a side view (FIG. 10) of an embodiment of a safety edge 116, both of the lamp assembly 122 of FIG. 1.

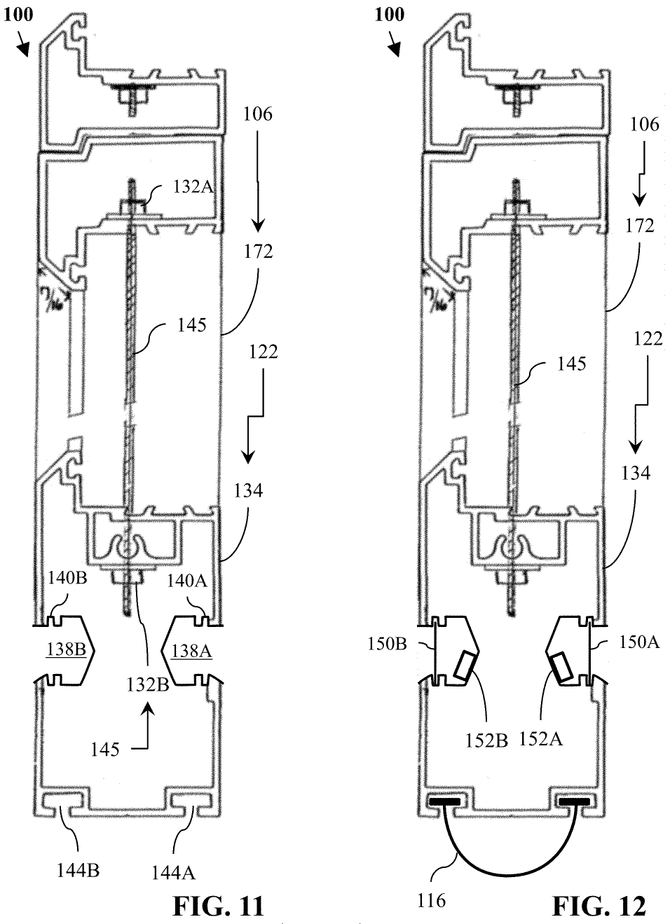

FIG. 11 and FIG. 12 depict cross-sectional side views (along the cross-sectional line A-A as depicted in FIG. 1) of embodiments of the lamp assembly 122 of FIG. 1.

Referring to the embodiment as depicted in FIG. 11, the components are not installed to the profile body 134 (to improve ease of viewing of the features of the lamp assembly 122). The garage door panel 106 includes (and is not limited to) a rigid garage door panel 172 (made of steel). The first connector 132A and the second connector 132B connect the profile body 134 to the bottom section of the rigid garage door panel 172.

Referring to the embodiment as depicted in FIG. 12, the components are installed to the profile body 134.

FIG. 13 depicts a cross-sectional view (through a cross-sectional line B-B as depicted in FIG. 1) of an embodiment of the lamp assembly 122 of FIG. 1 and a first door-release device 118A of the garage door panel 106 of FIG. 1.

FIG. 14 depicts a side view of an embodiment of the first door-release device 118A of FIG. 13.

Referring to the embodiment as depicted in FIG. 13, the first door-release device 118A is configured to be slidably received (at least in part) into the end portion of the profile body 134. The profile body 134 includes the support portions 165 that abut (slidably abut) the outer sides of the first door-release device 118A. The profile body 134 includes a lateral cross-brace 167 that bisects the interior of the profile body 134 into the first conduit 160 and the second conduit 162.

Referring to the embodiment as depicted in FIG. 14, the first door-release device 118A includes a first extended portion 168 and a second extended portion 170. The first door-release device 118A defines (provides) a groove 166 separating the first extended portion 168 and the second extended portion 170. The groove 166 is configured to slidably receive the lateral cross-brace 167 (also depicted in FIG. 13).

FIG. 15 and FIG. 16 depict top views of embodiments of the first door-release device 118A of FIG. 13 with the garage door panel 106 of FIG. 1.

Referring to the embodiment as depicted in FIG. 15, the first door-release device 118A is engaged (slide engaged) with (a first elongated groove 121A of) the second garage door support 120B. The second door-release device 118B is engaged (slide engaged) with (a second elongated groove 121B of) the first garage door support 120A. The first elongated groove 121A extends vertically along a length of the second garage door support 120B. The second elongated groove 121B extends vertically along a length of the first garage door support 120A. The first door-release device 118A is configured to slide engage with, or along a length of, (the first elongated groove 121A of) the second garage door support 120B. The second door-release device 118B is configured to slide engage with, or along a length of, (the second elongated groove 121B of) the first garage door support 120A. The garage door panel 106 may be moved upwardly or downwardly (relative to the face of FIG. 15), and the first door-release device 118A remains vertically slide engaged with the second garage door support 120B, and the second door-release device 118B remains vertically slide engaged with the first garage door support 120A.

Referring to the embodiment as depicted in FIG. 16, for the embodiment as depicted, the garage door panel 106 includes a flexible rubber sheet (curtain). The first door-release device 118A is configured to permit the garage door panel 106 to become disengaged from the second garage door support 120B, once the vehicle 902 moves along the vehicle movement direction 903 and the vehicle 902 impacts (strikes) one side of the garage door panel 106, and the garage door panel 106 centrally buckles or deforms (centrally bows outwardly). The second door-release device 118B is configured to permit the garage door panel 106 to become disengaged from (the second elongated groove 121B of) the first garage door support 120A, once the vehicle 902 moves along the vehicle movement direction 903 and the vehicle 902 impacts (strikes) one side of the garage door panel 106, and the garage door panel 106 centrally buckles or deforms (centrally bows outwardly).

Referring to the embodiment as depicted in FIG. 15 and FIG. 16, the profile body 134 is configured to be attached to a garage door panel 106 including a flexible rubber sheet. A door-release device 118 is configured to be slidably received, at least in part, into the end portion of the profile body 134. The profile body 134 includes a support portion 165 (as depicted in FIG. 13) that slidably abuts an outer side of the door-release device 118. The door-release device 118 is configured to slide engage with a garage door support 120 along a length of an elongated groove 121 extending vertically along a length of the garage door support 120. The garage door panel 106 is movable while the door-release device 118 remains vertically slide engaged with the garage door support 120. The door-release device 118 is configured to permit the garage door panel 106 to become disengaged from a garage door support 120, once a vehicle 902 strikes a side of the garage door panel 106, and the garage door panel 106 centrally buckles.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a lamp assembly; and
a clamp assembly configured to securely attach the lamp assembly to a section of a garage door panel.

2. The apparatus of claim 1, wherein:
the clamp assembly is configured to attach the lamp assembly to a bottom edge of the garage door panel.

3. The apparatus of claim 1, wherein:
the lamp assembly is positioned, at least in part, in-line within the garage door panel once the clamp assembly attaches the lamp assembly to the section of the garage door panel.

4. The apparatus of claim 1, wherein:
the lamp assembly is positioned and mounted, at least in part, in-line within a vertical axis that extends along the garage door panel once the clamp assembly attaches the lamp assembly to the section of the garage door panel.

5. The apparatus of claim 1, wherein:
the garage door panel includes a flexible rubber sheet.

6. The apparatus of claim 1, wherein:
the lamp assembly is configured to emit a flashing light once the lamp assembly is activated in response to movement of the garage door panel.

7. The apparatus of claim 1, wherein:
the lamp assembly includes a profile body.

8. The apparatus of claim 7, wherein:
the profile body is configured to be attached along a bottom edge portion of the garage door panel.

9. The apparatus of claim 7, wherein:
the profile body includes a door contact portion extending from the profile body; and
the garage door panel is configured to be sandwiched between the door contact portion of the profile body and a connector support.

10. The apparatus of claim 7, wherein:
the lamp assembly includes the profile body defining a hollow interior; and
the profile body includes a door contact portion extending from the profile body; and
a connector channel is formed in the door contact portion; and
a top section of the profile body forms a plate receiver configured to receive, at least in part, a frontal edge portion of a connector support of the clamp assembly.

11. The apparatus of claim 7, wherein:
the profile body is configured to form at least one lamp receiver.

12. The apparatus of claim 7, wherein:
the profile body forms a first lamp receiver and a second lamp receiver each of which are positioned on opposite faces of the profile body, in which the opposite faces of the profile body are positioned at the opposite sides of the garage door panel once the clamp assembly attaches the lamp assembly to the section of the garage door panel.

13. The apparatus of claim 7, wherein:
the profile body includes a sensor receiver configured to receive and support a sensor assembly; and
the sensor assembly is configured to detect pressure of the garage door panel closing down to a work surface.

14. The apparatus of claim 7, wherein:
the profile body includes at least one seal receiver configured to receive and support a safety edge.

15. The apparatus of claim 7, comprising:
the profile body defines a first conduit and a second conduit, which are spaced apart from each other; and
the profile body includes a lateral cross-brace that bisects an interior of the profile body into the first conduit and the second conduit.

16. The apparatus of claim 1, further comprising:
a sensor assembly configured to be fixedly mounted to a bottom section of the lamp assembly; and
a safety edge configured to be fixedly mounted to the bottom section of the lamp assembly; and
the safety edge also configured to cover the sensor assembly once the sensor assembly and the safety edge are fixedly attached to the bottom section of the lamp assembly.

17. The apparatus of claim 1, further comprising:
a sensor assembly configured to be fixedly mounted to a bottom section of the lamp assembly; and
the sensor assembly including:
an air-tube assembly; and
a conduit assembly; and
a pressure sensor; and
wherein the air-tube assembly is mounted to the bottom section of the lamp assembly; and
the pressure sensor is mounted to an outer facing side of the lamp assembly; and
the conduit assembly fluidly connects the pressure sensor with the air-tube assembly.

18. The apparatus of claim 1, wherein:
the garage door panel includes a rigid garage door panel.

19. An apparatus, comprising:
a garage door panel; and
a lamp assembly having a clamp assembly; and
the clamp assembly configured to be securely attached to a section of the garage door panel.

20. An apparatus, comprising:
a lamp assembly; and
a clamp assembly configured to securely attach the lamp assembly to a section of a garage door panel; and
the lamp assembly positioned, at least in part, in-line within the garage door panel once the clamp assembly attaches the lamp assembly to the section of the garage door panel; and
the lamp assembly including a profile body defining a hollow interior; and
the profile body forming a first lamp receiver and a second lamp receiver that are positioned on opposite faces of the profile body, in which the opposite faces of the profile body are positioned at the opposite sides of the garage door panel once the clamp assembly attaches the lamp assembly to the section of the garage door panel; and
the profile body also configured to receive and support a sensor assembly, and the sensor assembly is configured to detect pressure of the garage door panel closing down to a work surface; and
the profile body also configured to receive and support a safety edge, and the safety edge is configured to cover the sensor assembly once the sensor assembly and the safety edge are attached to the lamp assembly.
